(19) United States
(12) Patent Application Publication
(10) Pub. No.: US 2013/0256239 A1
(43) Pub. Date: Oct. 3, 2013

(54) COORDINATED SYSTEM AND METHOD FOR TREATING WATER

(71) Applicants: Mitch Saccoccio, Clarksville, VA (US); Jonathan Bonelli, New York, NY (US)

(72) Inventors: Mitch Saccoccio, Clarksville, VA (US); Jonathan Bonelli, New York, NY (US)

(73) Assignee: Asia Connection LLC., New York, NY (US)

(21) Appl. No.: 13/431,309

(22) Filed: Mar. 27, 2012

(51) Int. Cl. G01N 21/80; C02F 1/66; C02F 5/08; C02F 1/76

(52) U.S. Cl. 210/754; 436/163; 210/749

(57) ABSTRACT

A coordinated system for the treatment of water includes (a) a test kit including an indicator having a changeable color which is adapted to a predetermined aqueous environmental condition and an associated chart including colors associated with a range of environmental conditions; and at least one chemical agent having a color which corresponds to a color of the indicator associated with an environmental condition outside of a desired range.

### BACKGROUND

1. Field of the Invention

The present invention relates to a system for treating water, and in particular for the treatment of recreational water such as in swimming pools, hot tubs and spas.

2. Background of the Art

Recreational water, such as the water in swimming pools, hot tubs and spas, needs to be carefully monitored to avoid the buildup of bacteria, viruses, algae and other microorganisms which can cause irritation to the exposed skin of the bathers or even illness. Typically, chemicals are added to the water to kill or suppress the growth of such microorganisms. However, adjusting the chemical properties of the water can be complex. Yet, since the skin of the bathers is in. contact with the water it is important to provide a sanitary environment without causing irritation. This requires a careful balance of the chemical additives.

For example, pool water should be kept at a pH of from 7.2 to 7.6. Human skin is at a pH of about 7.4. Pool water which is acidic (pH below 7.0) or which is overly basic (pH above 7.6), can be irritating to the human skin and eyes. Moreover, acidic pH can promote corrosion of metal fittings and other pool fixtures. On the other hand, high pH, especially pH above 8.0, can result in the formation of scale deposits on the pipework and fittings.

Sanitizing agents are added to the water to kill bacteria, viruses and algae. Such agents can include, for example, chlorinating agents such as the hypochlorites of sodium or calcium, or sodium dichloroisocyanurate dihydrate (“dichlor”) or trichloroisocyanuric acid (“trichlor”). Also used are brominating agents such as bromochlorodimethylhydantoin (“BCDMH”). Chlorinating agents are typically more often used than brominating agents because of the difference in cost.

However, the pH level can affect the chlorine (or bromine) activity of the water and, consequently, the resulting sanitizing effect. For example, at a pH level of 7.0 the chlorine activity of free hypochlorous acid (HOCl) is 73%, whereas at a pH of 8.0 the chlorine activity drops to 21%.

Another feature of the water is its alkalinity, which determines the buffering ability of the water to resist changes in pH. Alkalinity is due to the presence of carbonate ions (CO₃⁼). Alkalinity should be kept at a level of from about 80 ppm to about 125 ppm. If alkalinity is too low it may become too difficult to maintain a desired pH level because of fluctuations. On the other hand, if alkalinity is too high the result may be “pH lock” in which it becomes difficult to change the pH.

The hardness of the water is yet another factor. Generally, the hardness is caused by the presence of calcium or magnesium ions. Calcium hardness should be within a range of 200-400 ppm calcium ions. If hardness is too low the water can be corrosive to the pool walls and metal parts. If the hardness is too high the result can be calcification, scale formation and eye irritation.

It can be readily seen that balancing of these factors can be a complex undertaking. To assist the consumer, various kits are available to test the aqueous environmental conditions of the water, i.e., for example properties such as, pH level, chlorine and/or bromine activity, alkalinity and hardness, and any other conditions relevant to the maintenance of recreational water. What is needed is a simple method for the consumer to adjust the properties of the water based on the test results to maintain proper pool chemistry.

### SUMMARY

Provided herein is a coordinated system for the treatment of water. The system includes (a) a test kit including an indicator having a changeable color which is adapted to a predetermined aqueous environmental condition and an associated chart including colors associated with a range of environmental conditions; and at least one chemical agent having a color which corresponds to a color of the indicator associated with an environmental condition outside of a desired range.

Also provided herein is a method for treating water which comprises: (a) providing the aforementioned coordinated system for the treatment of water; (b) contacting the indicator with the water; (c) observing the color of the indicator in the water; (d) comparing the color of the indicator in the water with the colors of the chart to determine whether the level of the environmental condition is within a desired range; (e) if the environmental condition is outside the desired range, selecting a chemical agent having the same color as the indicator; and (f) adding an appropriate quantity of the selected chemical agent to the water until the environmental condition is within the desired range.

### BRIEF DESCRIPTION OF THE DRAWINGS

FIG. 1 is an illustration of the system of the present invention.

### DETAILED DESCRIPTION OF PREFERRED EMBODIMENT(S)

The coordinated system of the invention includes test kits adapted for the testing of the properties of recreational water and chemical agents for adjusting the measured properties to desired levels. The test kits include chemical indicators, which provide a color indication of the level of the measured property. The chemical agents for adjusting the specific property include a dye or particles which are colored in coordination with the color indicated by the test kit.

For example, a kit for testing the pH of water can include a halochromic indicator (i.e., an indicator which changes color in response to changes in pH) such as phenol red, which is yellow at a below 6.8 and red at a pH above 8.2. A pH testing kit will therefore include a solution containing a phenol red indicator and a chart showing the color of the indicator at pH intervals from 6.8 to 8.2. The user adds drops of the indicator solution to a quantity of water and then compares-the resulting color with the color chart to find the matching pH. Alternatively, the indicator can be in the form of test strips which can be dipped into the water. The test strips will change color to indicate the pH of the water. Once again, the use compares the color of the test strip with the color chart to determine the pH of the water.

With respect to adjustment of the pH level, the coordinated system of the invention includes a water balancing chemical which is colored to match the condition which the user intends to correct. Accordingly, in the event that pH is too high (i.e., the indicator has turned red) the system will include an acidic chemical such as sodium bisulfate (NaHSO₄) which has been colored red (e.g., by the addition of inert red particles or red dye) or muriatic acid (HCl) which has been colored red.

The system will also include a chemical to raise the pH should the test kit indicate a pH which is too low (i.e., the indicator becomes yellow). Such chemicals include sodium carbonate (NaCO₃) to which, in the system of the invention, has been added inert yellow particles or dye.

The system of the invention is easy to use since the consumer need only select the chemical agent having a color matching the color of the indicator. The recreational water is then dosed with the chemical agent until the pH is within an acceptable range. The system is advantageous in that the chemical agent, and not just its container or label, is color coordinated. Accordingly, the chemical agent can be packaged in a transparent container so that the quantity as well as the type of chemical agent is readily seen.

While the color coordinated system of the invention has been exemplified with respect to the pH testing and correction of recreational water, the other relevant properties can also be treated. For example, the test kit can test for chlorine or bromine content, alkalinity or hardness. In each case, the level of the property can be determined by comparison with a corresponding color chart which displays a series of colors identified with the color of the indicator at various intervals of the level of the measured property. By comparison of the actual color of the indicator in the tested water with the colors on the associated chart, the user can determine whether the measured property falls within the desired range. If necessary, the chemical agent having a color matching that of the indicator can be added to the water to correct any imbalance.

Various colorants, including pigments and dues, are known in the art and are commercially available. Once skilled in the art can select a suitable inert colorant for the chemical additive.

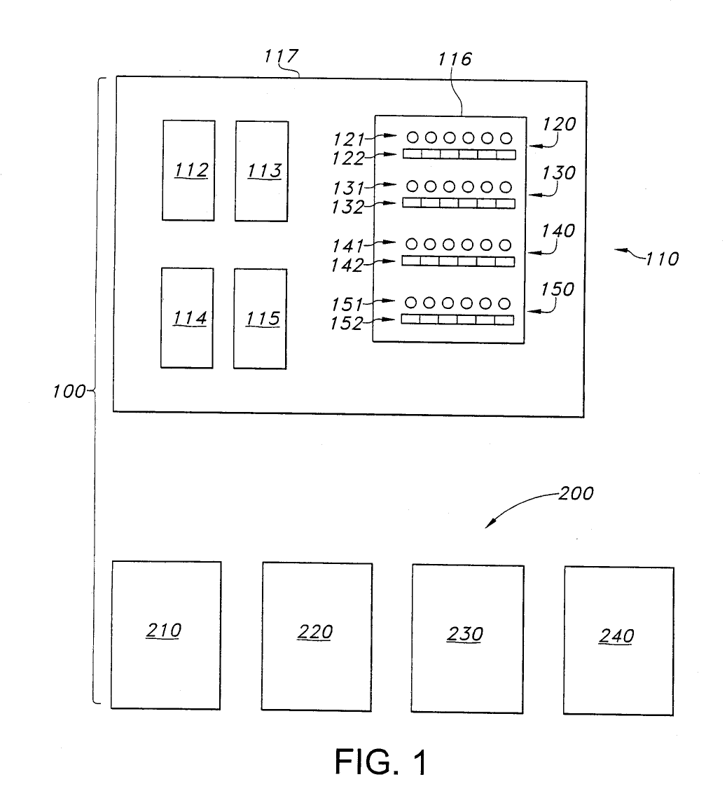

Referring now to FIG. 1, in an embodiment the system 100 of the invention includes a test kit 110 and one or more containers 200 of chemical agents. The test kit 110 is enclosed in a container 111, which can be a box, or package, and includes one or more indicator means (112, 113, 114, 115) for measuring predetermined environmental features of recreational water and a chart 116 for displaying an array of resulting colors of the indicators and the corresponding ranges of magnitude of the tested feature which correspond to the colors.

The indicator means, 112, 113, 114 and 115, can be in the form of test strips impregnated with a color changing chemical, or solutions containing the color changing chemical. For example, indicator means 112 can include a plurality of test strips containing a halochromic indicator such as phenol red for determining the pH level. The color chart 116 includes a pH chart having a plurality of reference colors 121 and a range of pH values 122 associated with the corresponding reference colors from yellow (indicating a low pH) to red (indicating a high pH).

The pH adjustment chemicals 210 can include a container 210 of particles of sodium carbonate which are colored yellow and a separate container of particles of sodium bisulfate which are colored red. Accordingly, if the pH as measured by the indicator means 112 is too acidic, as determined by comparison of the indicator color with the reference colors of the chart 121, a quantity of yellow sodium carbonate is added to the water to increase the pH. Conversely, if the pH is determined to be too high, a quantity of red sodium bisulfate particles is added to the water to reduce the pH.

Indicator means 113, can be for the measurement of the chlorine activity of the water. Chart 116 can therefore include a chlorine activity chart including a range of reference colors 131 with a corresponding range of chlorine activity values 132. The chlorine adjustment chemical agents can include a quantity of calcium hypochlorite particles 220 which are colored to match the appropriate color as indicated by the reference colors 131. Also included can be a separate package of chlorine stabilizer such as cyanuric acid.

Indicator means 114 can be for the measurement of alkalinity of the water. Chart 116 can include an alkalinity level chart including a range of colors 141 with a corresponding range of alkalinity levels 142. The chemical agents 230 can include a container of colored muriatic acid to reduce alkalinity and a separate container of sodium carbonate to increase alkalinity.

Indicator means 115 can be for the measurement of hardness of the water. Chart 116 can include a water hardness level chart including a range of colors 151 with a corresponding range of hardness levels 152. The chemical agent 240 can include a colored calcium chloride to increase water hardness. Excess hardness is usually treated by replacing some of the water with fresh water.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A coordinated system for treating water which comprises:
a) a test kit including an indicator having a changeable color which is adapted to at least one predetermined aqueous environmental condition and an associated chart including colors associated with a range of environmental conditions; and
b) at least one chemical agent having a color which corresponds to a color of the indicator associated with an environmental condition outside of a desired range.

2. The system of claim 1 wherein the indicator is a halochromic indicator and the environmental condition is the pH of the water.

3. The system of claim 2 wherein the at least one chemical agent includes an acidic agent to lower the pH of the water.

4. The system of claim 3 wherein the at least one chemical agent comprises sodium bisulfate or muriatic acid.

5. The system of claim 2 wherein the at least one chemical agent includes a basic chemical agent to raise the pH of the water.

6. The system of claim 5 wherein the chemical agent is sodium carbonate.

7. The system of claim 3 wherein the halochromic indicator is red in an alkaline environmental and the acidic agent includes a red colorant.

8. The system of claim 5 wherein the halochromic indicator is yellow in an acid environment and the basic chemical agent includes a yellow colorant.

9. The system of claim 2 wherein the halochromic indicator includes phenol red.

10. The system of claim 1 wherein the indicator has a color which changes in response to the chlorine content of the aqueous environment.

11. The system of claim 1 wherein the indicator has a color which is responsive to the bromine content of the aqueous environment.

12. The system of claim 1 wherein the indicator has a color which is responsive to the water hardness of the aqueous environment.

13. The system of claim 1 wherein the indicator has a color which is responsive to the alkalinity of the aqueous environment.

14. The system of claim 1 wherein the aqueous environment is recreational water associated with a swimming pool, spa or hot tub.

15. A method for treating water comprising:
a) providing the system of claim 1;
b) contacting the indicator with the water;
c) observing the color of the indicator in the water;
d) comparing the color of the indicator in the water with the colors of the chart to determine whether the level of the environmental condition is within a desired range;
e) if the environmental condition is outside the desired range, selecting a chemical agent having the same color as the indicator; and,
f) adding an appropriate quantity of the selected chemical agent to the water until the environmental condition is within the desired range.

16. The method of claim 15 wherein the water is recreational water associated with a swimming pool, spa or hot tub.

17. The method of claim 15 wherein the indicator is a halochromic indicator and the environmental condition is the pH of the water.

18. The method of claim 17 wherein the halochromic indicator is phenol red.

19. The method of claim 18 wherein the at least one chemical agent includes an acidic compound with a red colorant added thereto and a basic compound with a yellow colorant added thereto.

20. The method of claim 15 wherein the environmental condition is one or more of pH level, chlorine content, bromine contents, alkalinity, and/or water hardness.
